(19) United States
(12) Patent Application Publication
(10) Pub. No.: US 2020/0256023 A1
(43) Pub. Date: Aug. 13, 2020

(54) Portable Sign

(71) Applicant: Brady Group SAS, Roncq Cedex (FR)

(72) Inventor: Luc Noël, Roncq Cedex (FR)

(21) Appl. No.: 16/519,908

(22) Filed: Jul. 23, 2019

Related U.S. Application Data
(60) Provisional application No. 62/802,302, filed on Feb. 7, 2019.

(51) Int. Cl. E01F 9/654; E01F 9/688; G09F 7/22

(52) U.S. Cl. CPC E01F 9/654; G09F 2007/1878; G09F 7/22; E01F 9/688

(57) ABSTRACT

A sign arrangement including a first planar member with a substantially V-shape and a first member slot and a second planar member with a substantially V-shape and a second member slot. The second member is removably receivable within the first member slot and the first member is removably receivable within the second member slot to form a substantially tripod-like structure. Regardless of the orientation of the sign arrangement relative to the ground, the sign arrangement is capable of displaying the information the sign arrangement is designed to convey.

### CROSS-REFERENCE TO RELATED APPLICATION

This application claims the benefit of U.S. Provisional Application No. 62/802,302, filed Feb. 7, 2019. The contents of that application are hereby incorporated by reference for all purposes as if set forth in their entirety herein.

### FIELD OF INVENTION

This disclosure relates to temporary indoor/outdoor displays such as portable sign arrangements that may be set up at a location of interest.

### BACKGROUND

Temporary signs can be instructive, informative, and often necessary to give notice to passers-by in a hurry about a current situation. However, many temporary signs are flimsy and do not effectively deliver the intended message if blown or tipped over. Still further, such signs may not be particularly compact in form—especially if the sign is not of a collapsible type—and may require a substantial footprint to store when the sign is not use.

### SUMMARY

A sign arrangement is disclosed herein in which two substantially planar V-shaped sections are interlocked or joined together to form a tripod-like structure having four legs in which each of the legs can have similar signage or indicia. In this way, if the sign arrangement is tipped over, the signage or indicia remains visible and on the upwardly-pointing leg. Still further, the V-shaped sections may be disassembled to provide two planar sections that are easy to store.

According to one aspect, a sign arrangement is provided with a first member with a first leg and a second leg extending from a first member central portion away from each other defining a first member crotch. The first member central portion has a first member slot. The first leg of the first member has a first distal portion with a first indicia portion and the second leg of the first member has a second distal portion with a second indicia portion. The sign arrangement further includes a second member with a first leg and a second leg extending from a second member central portion away from each other defining a second member crotch. The second member central portion has a second member slot. The first leg of the second member has a first distal portion with a first indicia portion and the second leg of the second member has a second distal portion with a second indicia portion. The first member central portion is configured to be removably receivable within the second member slot and the second member central portion is configured to be removably receivable within the first member slot.

In some forms, the first member slot may have a set of notches and the second member central portion may have a set of ridges receivable within the set of notches of the first member slot. Additionally, or alternatively, the second member slot may have a set of notches and the first member central portion may have a set of ridges receivable within the set of notches of the second member slot.

In some forms, when combined, the first member and the second member may form a tripod-like structure.

In some forms, the first member and the second member may be substantially identical to one another.

In some forms, the first member and second member may each be substantially planar.

In some forms, structure may be provided to provide stacking of the disassembled members for storage. For example, the first member may have a first member protuberance and the second member may have a second member pocket. The first member and the second member may then be stackable with the first member protuberance being received within the second member pocket. In some forms, additionally or alternatively, the first member may have a first member pocket and the second member may have a second member protuberance and the second member protuberance is receivable within the first member pocket.

In some forms, a barrier may be formed by releasably connecting one or more of the aforementioned sign arrangements together in a chain. For example, a first member of one of the sign arrangements in the barrier may have a clip in the first member central portion that receives a rim of a distal portion on a leg of another one of the sign arrangements to releasably connect the sign arrangements together. In this way, a group of sign arrangements may be linked together to form a longer chain or lightweight barricade.

According to another aspect, a sign arrangement is provided with a first planar member and a second planar member. The first planar member is substantially V-shaped and has a first member slot located in a first member central portion of the first planar member. The second planar member also is substantially V-shaped and has a second member slot located in a second member central portion of the second planar member. The second member is removably receivable within the first member slot and the first member is removably receivable within the second member slot to form a substantially tripod-like structure.

In some forms, each of the planar members may have a pair of distal portions each with an indicia portion. Still further, the distal portions may be circular or ring shaped.

In some forms, the first member and the second member may be substantially identical to one another.

In some forms, the first member slot may have a set of notches and the second member central portion may have a set of ridges receivable within the set of notches of the first member slot. Additionally, or alternatively, the second member slot may have a set of notches and the first member central portion may have a set of ridges receivable within the set of notches of the second member slot.

In some forms, the first member may have a first member protuberance, the second member may have a second member pocket, and the first member and the second member may be stackable with the first member protuberance being receivable within the second member pocket. Additionally or alternatively, the first member may have a first member pocket, the second member may have a second member protuberance, and the first member and the second member may be stackable with the second member protuberance receivable within the first member pocket.

In some forms, a barrier may be formed by releasably connecting one or more of the aforementioned sign arrangements together in a chain. For example, the first planar member of one of the sign arrangements in the barrier may have a clip in the first member central portion configured to receive a rim of a distal portion of another one of the sign arrangements.

These and still other advantages of the invention will be apparent from the detailed description and drawings. What follows is merely a description of some preferred embodiments of the present invention. To assess the full scope of the invention the claims should be looked to as these preferred embodiments are not intended to be the only embodiments within the scope of the claims.

### BRIEF DESCRIPTION OF THE DRAWINGS

FIG. 1 is a perspective view of an embodiment of a sign arrangement in an assembled state.

FIG. 2 is a front elevation view of one of the members of the sign arrangement of FIG. 1 apart from the other member, which is identical in structure.

FIG. 3 is a perspective view of a sign arrangement illustrating that various types of replaceable mesh-type signs may be received in the distal portions of the legs.

FIG. 4A is a front elevation view of an end of a leg of another embodiment of a sign arrangement.

FIG. 4B is a top cross-sectional of the embodiment shown in FIG. 4A.

FIG. 5 is a perspective view of yet another embodiment of a sign arrangement in an assembled state.

FIG. 6 is a front elevation view of one of the members of the sign arrangement shown in FIG. 5, which is identical to the other member of the sign arrangement.

FIG. 7 is a perspective exploded view of the sign arrangement shown in FIG. 5 showing the two members from FIG. 6 apart from one another.

FIG. 8 is a side elevation view of a plurality of the sign arrangements shown in FIG. 5 interconnected to form a barrier or barricade.

FIG. 9 is a perspective of the plurality of the sign arrangements shown in FIG. 8.

FIG. 10 is a perspective view of a plurality of the sign members shown in FIG. 6 stacked together in a co-parallel arrangement.

FIG. 11 is detailed cross-sectional view of the stacked sign members of FIG. 10 taken along line 11-11.

FIG. 12 is a side elevation view of another embodiment of a sign arrangement with a marking provided on the distal portions of the legs.

### DETAILED DESCRIPTION

Before any embodiments of the invention are explained in detail, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Some of the discussion below describe signage arrangements that can be used to provide cautionary indications or messages to passersby. The context and particulars of this discussion are presented as examples only. For example, embodiments of the disclosed invention can be used to disseminate many different types of messages not limited to warnings, such as advertising or instructional messages.

Some of the discussion below also describes the construction of the signage arrangements. The context and particulars of this discussion are presented as examples only. For example, embodiments of the disclosed invention can be constructed from a variety of differently shaped components that are assembled in various configurations, only some of which will be described herein.

In conventional methods, temporary signage may consist of a folding sign with a hinge connecting two planar members at one end (e.g., a “sandwich board” style) and which may be separated to provide a base when the sign is in use. This arrangement is generally unstable in windy areas or areas with high foot traffic that can lead to the sign being bumped into and collapsing. Additionally, this type of sign is also only visible from two directions (i.e., the directions perpendicular to the planes defined by the planar members).

Embodiments disclosed herein address these visibility issues, stability issues, and other issues. For example, in some embodiments, a signage arrangement can convey a message to passersby that can be upended by wind or physical contact and yet continue to convey the message given its generally tetrahedral shape with signage on all four legs.

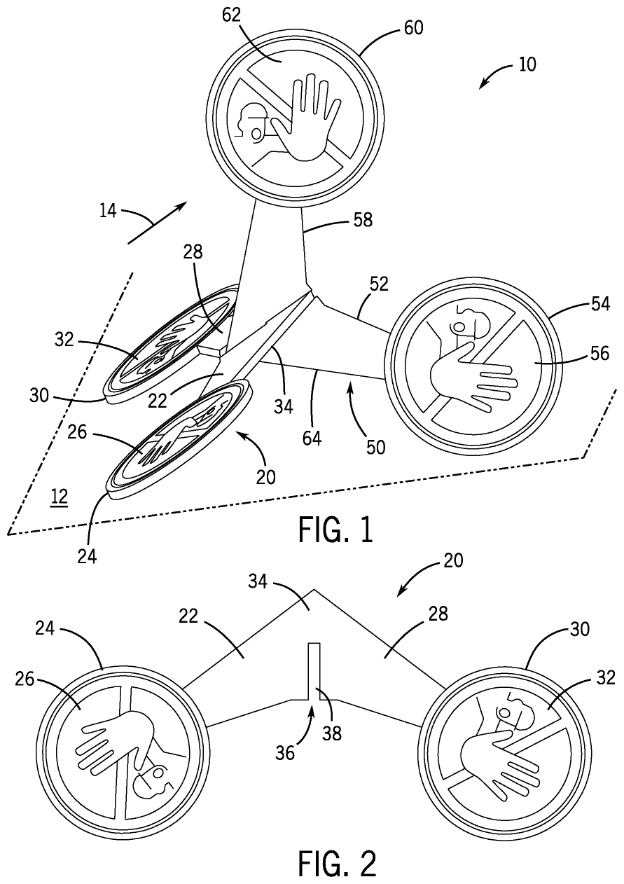

FIG. 1 illustrates an exemplary sign arrangement 10 in an assembled state. The sign arrangement 10 has a first member 20 and a second member 50 that is substantially identical to the first member 20. With forward reference also being made to FIG. 2, the first member 20 has a first leg 22 and a second leg 28 extending from a first member central portion 34 and away from each other and defining a shape for the first member 20 similar to a “V” shape or boomerang shape. The first member 20 and the second member 50 are each generally or substantially planar as illustrated.

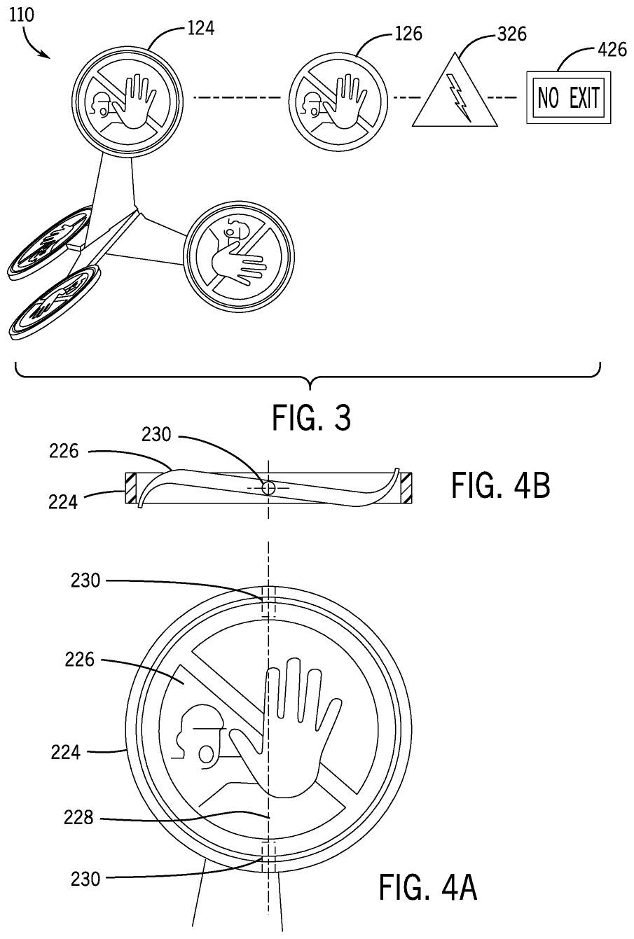

Each of the first and second legs 22, 28 has an indicia portion 26, 32 at distal portions 24, 30 thereof. The indicia portions 26, 32 as shown in FIGS. 1 and 2 are substantially planar and include a first side and a second side on which indicia can be provided. As illustrated in FIGS. 1 and 2, the indicia portions 24, 30 are circular; however, other shapes are contemplated for the indicia portions 26, 32, such as a triangular indicia portion 326 and a rectangular indicia portion 426 as are shown in FIG. 3.

It should be understood that the second member 50 has equivalent elements to that of the first member 20 and structured in much the same way, if not identically. For example, the second member 50 has a first leg 52 with a distal portion 54 and an indicia portion 56 and a second leg 58 with a distal portion 60 and an indicia portion 62, in which the first leg 52 and the second leg 58 extend away from each other from a second member central portion 64 and defining a shape for the second member 50 similar to a “V” shape or boomerang shape. The second member 50 is also substantially planar.

Looking at FIG. 2 in which the first member 20 is shown in isolation, the first member 20 is shown having a slot 38 extending into the first member central portion 34 thereof from the crotch 36 of its “V” shapes. A similar slot (which would be given the reference number 68, but is not specifically labeled in FIG. 1) is found in the second member 50.

Returning again to FIG. 1, in which the first member 20 and the second member 50 are shown in the assembled state, the slot 38 of the first member 20 is configured to receive the second member central portion 64, and, similarly, the slot 68 of the second member 50 is configured to receive the first member central portion 34. In this configuration, the first member plane is perpendicular to the second member plane to form a tripod-like structure that is substantially symmetrical.

FIG. 3 illustrates another embodiment of a sign arrangement 110 in which indicia portion 126 is removable from the distal portion 124 of each of the legs. This provides the ability to swap various types of indicia portions 126 onto the sign arrangement 110. For example, the distal portions 124 may be ring-shaped as shown in FIG. 3 and the indicia portion 126 may be configured to fit within the ring-shaped distal portion 124 and maintain position through an interference fit or other engagement mechanism such as a clasp.

Another embodiment can provide for single-sided indicia portions which incorporate an attachment mechanism such as a snap or a hook-and-loop type material, on the non-indicia side, to engage with a complementary type of attachment mechanism provided on the distal portions.

Another embodiment can include indicia portions that are configured to receive the distal portions therein through an expandable open end and retained around the distal portions through a drawstring, an elastic band, or other tightening mechanism incorporated into the expandable open end.

The indicia portions in any embodiment may also comprise a mesh-type material configured to have a low-wind resistance to prevent the sign arrangement 10 from being blown around when outside on a windy day.

FIGS. 4A and 4B illustrates another variation of a distal portion 224 of a sign arrangement. In these figures, the distal portion 224 includes an indicia portion 226 received within the distal portion 224 and attached thereto with at least one pin (here shown as a pair of pins 230) along an indicia portion axis 228. The pair of pins 230 are configured to allow the indicia portion 236 to spin within and relative to the distal portion 224. In this way, wind is less likely catch the indicia and flip the sign—although if it did, the sign assembly would simply flip to another viewable orientation. As illustrated in FIG. 4B, the indicia portion 226 can have shaped surfaces to encourage the indicia portion 226 to rotate in one direction over the other when in the presence of wind.

Accordingly, in use, the sign arrangement 10 is configured to overcome an upending event or, if an upending event occurs, the sign arrangement 10 is configured to remain functional. For example, looking at FIG. 1, the sign arrangement 10 is shown as positioned with the distal portions 24, 30 of the first and second legs 22, 28 of the first member 20 and the distal portion 54 of the first leg 52 of the second member 50 on a surface 12 with the distal portion 60 of the second leg 58 of the second member 50 spaced above the surface 12. In the event a force is applied to the distal portion 60 of the second leg 58 of the second member 50, represented by force vector 14 and in the event the force is great enough to tip the sign arrangement 10 over in the direction of the force vector 14, the sign arrangement 10 will be reoriented with the distal portions 54, 60 of the first and second legs 52, 58 of the second member 50 and the distal portion 24 of the first leg 22 of the first member 20 on the surface 12 with the distal portion 30 of the second leg 28 of the first member 20 spaced above the surface 12. In this way, the sign arrangement 10 will never be compromised if upended because the lifted leg becomes the new upward leg and the previous upward leg becomes one of the supporting base legs engaging the ground.

Further, the first member 20 and the second member 50, as shown in FIGS. 1 and 2, are removably connectable with one another. When separated, the first member 20 and the second member 50 can be stored in a stacked fashion in which the first member plane of the first member 20 is substantially parallel with the second member plane of the second member 50. This configuration allows for ease of storage and for quick assembly of the sign arrangement 10 when needed.

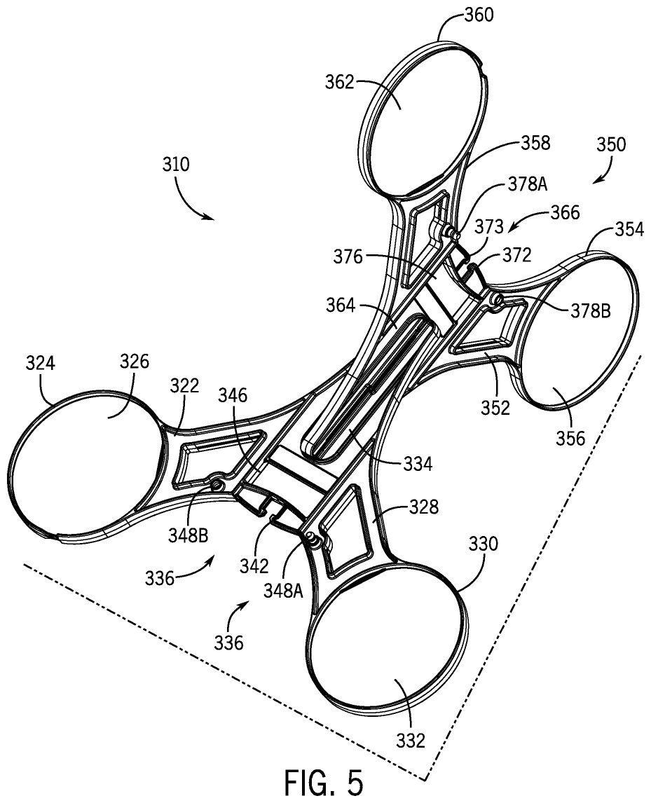

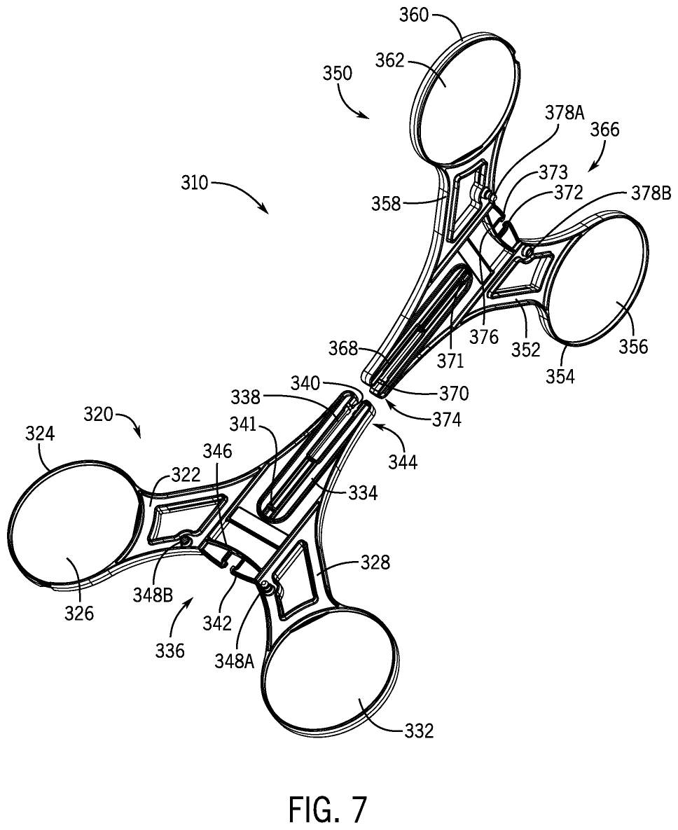

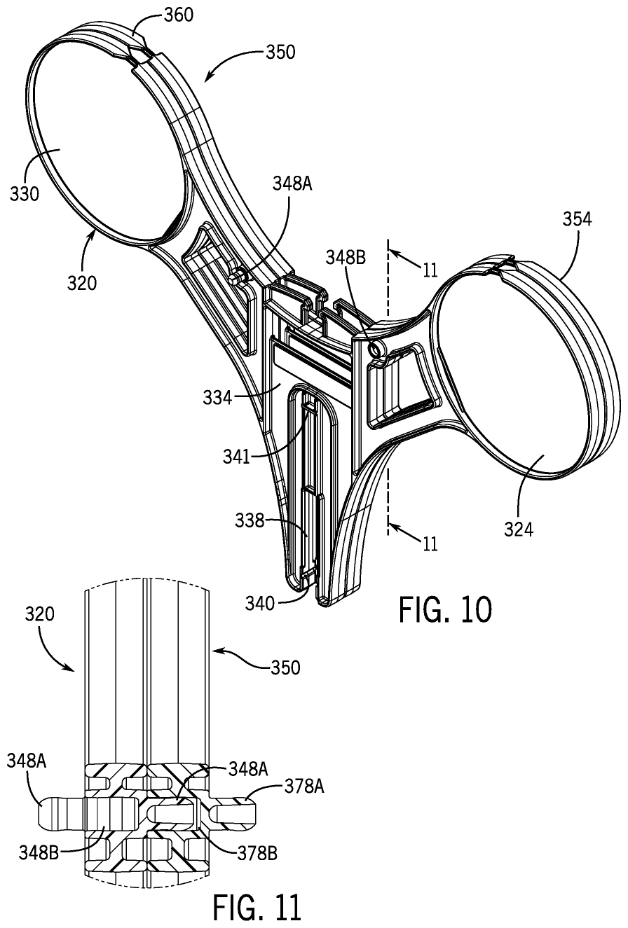

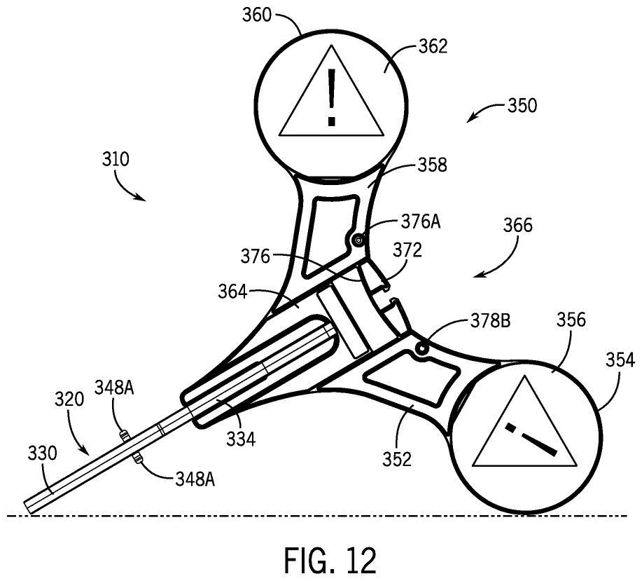

FIGS. 5-10 illustrate another embodiment of a sign arrangement 310. In many aspects, the sign arrangement 310 is similar to the sign arrangement 10 described above and similar numbering is used for the sign arrangement 310 as is used for the sign arrangement 10. For example, the sign arrangement 310 includes a first member 320 and a second member 350. The first member has a first leg 322 and a second leg 328 disposed from a first member central portion 334 and extending away from each other to define a shape for the first member 320 similar to a “V” shape or boomerang shape. Further, the first leg 322 has a distal portion 324 and an indicia portion 326, and the second leg 328 also has a distal portion 330 and an indicia portion 332. The first member central portion 334 has a crotch 336 and an engagement slot 338 (best seen in FIG. 7). Similarly, the second member 350 has a first leg 352 and a second leg 358 disposed from a second member central portion 364 and extending away from each other to define a shape for the second member 350 similar to a “V” shape or boomerang shape. Moreover, the first leg 352 has a distal portion 354 and an indicia portion 356, and the second leg 358 has a distal portion 360 and an indicia portion 362. An example of indicia (a caution symbol) provided on the sign arrangement 310 is shown in FIG. 12. The second member central portion 364 also has a crotch 366 and an engagement slot 368.

In some aspects, however, the sign arrangements 10, 310 differ from each other. For example, one way in which the sign arrangements 10, 310 differ is that the first member 320 and the second member 350 of the sign arrangement 310 have a handle 346, 376 and a clip 342, 372 in the crotch 336, 366. The handle 346, 376 is sized and configured to receive a human hand therein to enable an operator to carry or move the first and second members 320, 350 or the sign arrangement 310. It is further contemplated that the handle 346, 376 is configured to receive straps or rope that can be used for the same purpose in addition to other functions such as for tying multiple members 320, 350 or sign arrangements 310 together.

Another way the sign arrangement 310 differs from the sign arrangement 10 is that the engagement slot 338, 368 extends inward into the first and second member central portions 334, 364 from an apex 344, 374 opposite the crotch 336, 366. This is unlike the sign arrangement 10 in which the slots 38, 68 extend inward from the crotch 36, 66. Functionally, this alters the mode of assembly of the separate members. In the sign arrangement 10, both members are initially positioned such that the crotches first engage one another at the slots and the members are pushed from the inside of their V-shaped regions towards the bottom of the V. In contrast, in the sign arrangement 310, the apexes engage one another at the slots from the outside bottom of the peaks of each V and the members are inserted in a direction 180 degrees and to the direction of insertion of the members for the sign arrangement 10.

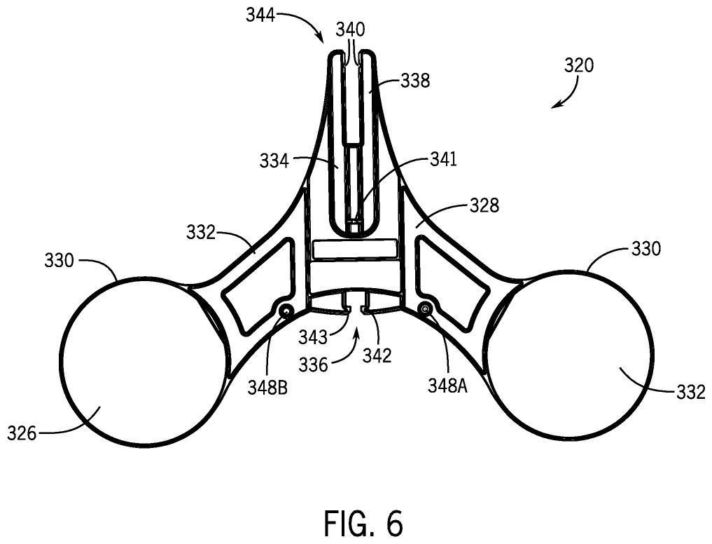

Furthermore, the sign arrangement 310 can also include an interlocking feature configured to releasably retain the engagement of the first member 320 and the second member 350 when in the assembled state as shown in FIG. 5 that is not illustrated in the first embodiment (but could also be present in that first embodiment). The interlocking feature can include a set of notches 340, 370 (shown best in FIG. 6) along the inside of the engagement slot 338, 368, respectively. The set of notches 340, 370 are configured to receive a set of ridges 341, 371 (shown best in FIG. 7) provided on both sides of the first and second members 320, 350 in the first and second member central portions 334, 364, respectively, and in line with the engagement slots 338, 368. The interaction between the set of notches 340, 370 and the set of ridges 341, 371 provide a more positive engagement of the first and second members 320, 350 and can also provide a tactile signal to a user that the first and second members 320, 350 are fully engaged. In this way, the two members are less likely to be inadvertently separable from one another.

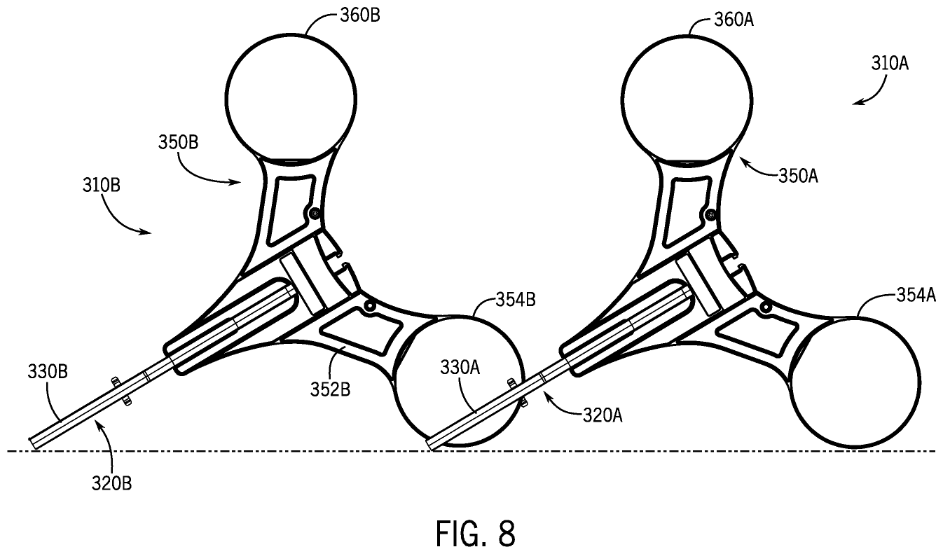

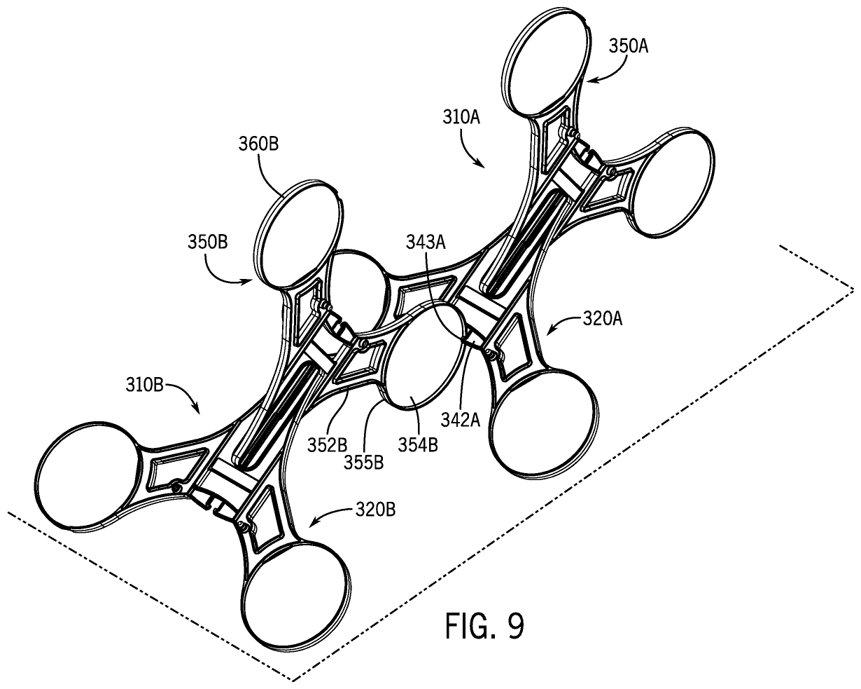

With reference to FIGS. 8 and 9, the clip 342, 372 is configured to join two sign arrangements 310 together, whereby a string of joined sign arrangements 310 can be formed into a barrier as shown in FIGS. 8 and 9. Looking at FIG. 9, for example, the clip 342A of a first sign arrangement 310A receives a rim 355B that extends along the periphery of the distal portion 354B of the first leg 352B of the second member 350B of a second sign arrangement 310B. The clip portion 372B can have pliable gate members 343B that allow for the reception and the removal of the rim 355A. Generally, the interaction between the distal end portion and the clip portion is one that is secure but not inseparable and can take any form that provides this functionality. While only two sign arrangements are shown linked together in FIGS. 8 and 9, it will be appreciated that any number of sign arrangements might be joined to create a barricade or barrier of a desired length.

Still another way the sign arrangement 310 differs from the sign arrangement 10 is the addition of a protuberance and a pocket to aid in stacking the sign members of multiple sign arrangements together in a flat configuration. As shown in FIGS. 5, 6, 10, and 11, each first and second sign member 320, 350 has a protuberance 348A, 378A and a pocket 348B, 378B in the first and second member central portions 334, 364 on both sides of the sign member 320,350. The protuberance 348A, 378A of one sign member 320, 350 is configured to be received within a pocket 348B, 378B of another sign member 320, 350.

The relationship between protuberance and pocket provide an ability to stack a plurality of sign arrangements together in an orderly fashion. Further contemplated is an interference fit between the protuberance and the pocket. It should be noted that an embodiment can include just one of a protuberance and a pocket on one side of the sign member and just one of the other, either a protuberance or a pocket, on the opposite facing side of the sign member in line therewith. There may be some advantage to having a protuberance and the pocket on each side as illustrated in the figures in that there is not a “sidedness” to the way in which the sign arrangements are stackable with respect to one another. Put differently, by consistently arranging a protuberance and the pocket on each major side surface, it does not matter which major face of a member is placed in contact with an adjacent member for stacking purposes.

Thus, a highly versatile sign arrangement is disclosed herein. Among other things, such sign arrangements can be structurally robust in that they are not easily upended, can be deconstructed for easy stacking, can be made in mass using projection molding processes, and can be linked together to form barricades or barriers. These are but some of the various advantages capable from the disclosed sign arrangements.

As noted above, it should be appreciated that various other modifications and variations to the preferred embodiments can be made within the spirit and scope of the invention. Therefore, the invention should not be limited to the described embodiments. To ascertain the full scope of the invention, the following claims should be referenced.

What is claimed is:

1. A sign arrangement comprising:
a first member with a first leg and a second leg extending from a first member central portion away from each other defining a first member crotch, the first member central portion has a first member slot, the first leg has a first distal portion with a first indicia portion, and the second leg has a second distal portion with a second indicia portion; and
a second member with a first leg and a second leg extending from a second member central portion away from each other defining a second member crotch, the second member central portion has a second member slot, the first leg has a first distal portion with a first indicia portion, and the second leg has a second distal portion with a second indicia portion;
wherein the first member central portion is configured to be removably receivable within the second member slot and the second member central portion is configured to be removably receivable within the first member slot.

2. The sign arrangement of claim 1, wherein the first member slot has a set of notches and the second member central portion has a set of ridges receivable within the set of notches of the first member slot.

3. The sign arrangement of claim 1, wherein the second member slot has a set of notches and the first member central portion has a set of ridges receivable within the set of notches of the second member slot.

4. The sign arrangement of claim 1, wherein, when combined, the first member and the second member form a tripod-like structure.

5. The sign arrangement of claim 1, wherein the first member and the second member are substantially identical.

6. The sign arrangement of claim 1, wherein the first member and the second member are each substantially planar.

7. The sign arrangement of claim 1, wherein the first member has a first member protuberance and the second member has a second member pocket and wherein the first member and the second member are stackable with the first member protuberance receivable within the second member pocket.

8. The sign arrangement of claim 1, wherein the first member has a first member pocket and the second member has a second member protuberance and wherein the first member and the second member are stackable with the second member protuberance receivable within the first member pocket.

9. The sign arrangement of claim 1, wherein the sign arrangement of claim 1 is releasably connected to another sign arrangement according to claim 1 in order to form a barrier.

10. The sign arrangement of claim 9, wherein the first member of one of the sign arrangements in the barrier has a clip in the first member central portion receiving a rim of a distal portion on a leg of another one of the sign arrangements.

11. A sign arrangement comprising:
a first planar member with a substantially V-shape and a first member slot located in a first member central portion of the first planar member; and
a second planar member with a substantially V-shape and a second member slot located in a second member central portion of the second planar member;
wherein the second member is removably receivable within the first member slot and the first member is removably receivable within the second member slot to form a substantially tripod-like structure.

12. The sign arrangement of claim 11, wherein the first planar member has a set of distal portions each with an indicia portion.

13. The sign arrangement of claim 11, wherein the second planar member has a set of distal portions each with an indicia portion.

14. The sign arrangement of claim 11, wherein the first member and the second member are substantially identical.

15. The sign arrangement of claim 11, wherein the first member slot has a set of notches and the second member central portion has a set of ridges receivable within the set of notches of the first member slot.

16. The sign arrangement of claim 11, wherein the second member slot has a set of notches and the first member central portion has a set of ridges receivable within the set of notches of the second member slot.

17. The sign arrangement of claim 11, wherein the first member has a first member protuberance and the second member has a second member pocket, wherein the first member and the second member are stackable with the first member protuberance receivable within the second member pocket.

18. The sign arrangement of claim 11, wherein the first member has a first member pocket and the second member has a second member protuberance, wherein the first member and the second member are stackable with the second member protuberance receivable within the first member pocket.

19. The sign arrangement of claim 11, wherein the sign arrangement of claim 11 is releasably connected to another sign arrangement according to claim 11 in order to form a barrier.

20. The sign arrangement of claim 19, wherein the first planar member of one of the sign arrangements in the barrier has a clip in the first member central portion configured to receive a rim of a distal portion of another one of the sign arrangements.
